(19) United States
(12) Patent Application Publication
(10) Pub. No.: US 2025/0243775 A1
(43) Pub. Date: Jul. 31, 2025

(54) METHOD FOR THE CONVERSION OF THERMAL ENERGY INTO ELECTRICAL ENERGY BASED ON AN ANTICLOCKWISE THERMALLY REGENERATED CYCLE COMBINED WITH THERMAL ACCELERATION, AND THE APPLICATION OF SAME

(71) Applicants: Wolfgang HARAZIM, Zwickau (DE); DIPLOMAT GESELLSCHAFT ZUR WIRTSCH. RESTRUKTURIERUNG UND WIRTSCHAFTSFÖRDERUNG MBH, Frankfurt am Main (DE)

(72) Inventor: Wolfgang HARAZIM, Zwickau (DE)

(21) Appl. No.: 17/773,594

(22) PCT Filed: Oct. 22, 2020
(86) PCT No.: PCT/DE2020/000253

§ 371 Date: Aug. 18, 2022

(30) Foreign Application Priority Data
Nov. 2, 2019 (DE) 10 2019 007 886.1

(51) Int. Cl. F01D 15/10

(52) U.S. Cl. CPC F01D 15/10; F05D 2220/76

(57) ABSTRACT

The invention relates to a method for the conversion of thermal energy into electrical energy based on an anticlockwise thermally regenerated cycle combined with thermal acceleration, and to the application of same, which can be used primarily in the energy industry. The method may include the working fluid cyclically passing through a large-volume compression, a heat exchanger cooling with condensation, small-volume expansion and the heat exchanger heating with evaporation.

The invention relates to a “process for the conversion of thermal energy into electrical energy based on an anticlockwise thermally regenerated cycle combined with thermal acceleration and its application”, which is primarily applicable in the field of energy management.

The globally increasing energy demand increases the anthropogenic burdens for climate and environment, because the used thermal cycle processes according to the state of the art for mobility and power generation mainly burn fossil energy sources, which additionally influence the air mixture of the atmosphere by exhaust gases.

In a thermal cycle, a working fluid passes through a series of process steps with various pressure, volume and temperature changes until it cyclically reaches the initial state. A Systemically, heating causes cooling and compression causes expansion in order to return to the initial state. If the compression takes place in a smaller state of the working fluid than the expansion in terms of volume, these are basically clockwise heat-power processes, which are used, for example, in gas turbines, steam or combined cycle power plants, diesel or gasoline engines. The compression work to be supplied and the thermal energy for heating increase the pressure and temperature state of the working fluid, thereby increasing the specific volume. When the expansion force or the mechanical energy and the heat energy for cooling are removed, the pressure, temperature and specific volume return to the initial state, after which a new cycle begins.

The ratio of benefit (expansion force minus compression work) to input (heat energy supplied) describes the efficiency of the heat-power processes. According to the 0th law of thermodynamics, heat is transferred from the hotter to the colder, after which the heat energy to be dissipated can only be released into the environment for cooling. In addition to the target quantity of force or mechanical energy, waste heat is also generated from the supplied heat energy, which can no longer be used in the cycle process, which is reflected mathematically in the Carnot factor. It depends only on the absolute values of the process boundary temperatures and represents the unattainable theoretical efficiency maximum for thermal clockwise power processes, which are based on the basic process of small-volume compression, heating, large-volume expansion and cooling and which are independent of internal circuit variants such as exhaust gas recuperation, inter-cooling, feed-water preheating, intermediate heating, turbo-charging, etc . . . . In order to achieve high efficiencies, these processes require high temperatures, mainly achieved by combustion, usually high pressures and a low ambient temperature for the waste heat, which creates anthropogenic burdens on the climate and the environment.

According to the state of the art, there is another thermal cycle process, which raises the temperature level of the supplied heat energy in the course of the process for useful purposes by means of work input and which, depending on the target size, is known as an anticlockwise refrigeration or heat pump process or generally as a work-heat process. The basic process is based on heating, large-volume compression, cooling small volume expansion and corresponds to the heat-power process but in reverse flow direction. Depending on the target variable, the benefit-to-effort ratio provides a coefficient of performance, which is the multiple of the compression work supplied. This cannot be increased arbitrarily, because the mathematical derivation of the theoretical maximum via the absolute values of the process boundary temperatures is again provided by the Carnot factor with (Tₘₐₓ Tₘₐₓ Tₘᵢₙ). The smaller the temperature difference between heat energy input and output, the greater the coefficient of performance and the lower the work input for compression.

In the clockwise heat-force process, after expansion, the waste heat ensures that the working fluid reaches the initial state, but is then missing in terms of amount in the following cycle, which increases the heat energy input. This is a non-changeable necessity in the context of clockwise power processes, the cause of the heat-power conversion deficit named after Carnot.

According to the state of the art, the thermal anticlockwise working heat processes cannot be used for power generation, since only in the reversible case the amount of compression energy to be supplied equals the amount of expansion energy to be dissipated in the return case. Under real conditions, more drive energy would have to be supplied to raise a temperature level for power generation than could be supplied by regeneration.

The invention is based on the task of reducing the anthropogenic burden on the climate and the environment by means of a new basic process.

According to the invention, the task is essentially solved by the characterizing features of claims 1 to 13. According to the state of the art, there is a separation of tasks in principle, an anticlockwise heat transfer by means of pressure increase through work supply or clockwise-power plus waste heat from heat energy supply.

Anticlockwise cold steam processes require compression work for propulsion, but could in principle regenerate thermally, since the cooling required for condensation of the working fluid takes place at a higher pressure and temperature level than the heating required for evaporation. Such a circuit variant did not make sense until now, since only the compression heat generated during compression would have to be dissipated, an elaborate confirmation of the mechanical heat equivalent known since 1842 an electrically operated radiator.

During the phase change from liquid to gas, water, for example, increases its volume by 1,624 times at a pressure of 1 bar and a temperature of 99.6° C., which corresponds to a work of volume change of 169.24 KJ/kg. This amount must be supplied thermally when, during evaporation in a specially designed heat exchanger, the fluid velocity accelerates with increasing volume flow across the flow cross-section. This converts thermal energy into kinetic flow energy, which on the one hand provides the compression work for the regenerated link process and on the other drives a downstream co-pressure turbine to generate electricity.

Combined with the thermally regenerated anticlockwise cold steam process at low differential pressure between condensation and evaporation, a new basic heat-power process is thus created, since cyclically in the process step heating during evaporation more usable volume change work is convertible via the thermal acceleration than is required for the compression work to maintain the internal circulation. The remaining kinetic flow energy that can be decoupled via a constant-pressure turbine corresponds exactly to the energetic amount to be supplied thermally. The anticlockwise heat transfer work process thus becomes the new anticlockwise heat power process, in that the thermal energy amounts circulate internally in cycles without waste heat.

The new basic heat-power process is characterized by the fact that the heat energy to be removed from the heat exchanger cooling (2) is completely transferred to the heat exchanger heating (4), that the large-volume compression (1) and small-volume expansion (3) must only maintain the pressure and temperature difference, which is needed for the heat transfer from the heat exchanger cooling (2) to the heat exchanger heating (4), that besides the evaporation process in the heat exchanger heating (4) between inlet and outlet additionally the volume increase for the increase of the flow energy, for thermal acceleration, is used, that the thermal heat energy supply (7) takes place with the heat exchanger thermal acceleration (5), that the heat exchanger thermal acceleration (5) takes over the heat transfer to the flowing working fluid, that the large-volume compression (1) uses parts of the flow energy, that the turbine (6) drives the generator (8) with the main part of the flow energy, that with the current dissipation (9) the electric energy export from the process is carried out, that the working fluid carries out the principle process steps: Condensation by heat transfer to evaporation (10), first heating for thermal acceleration and then expansion or reverse order (11), evaporation by regenerated heat transfer from condensation combined with thermal acceleration (12), first speed reduction in the turbine and then compression or reverse order (13), cyclically.

The problem is thus solved. The most significant advantage of the invention is the elimination of heat dissipation to the environment, which not only improves efficiency, but there is no longer any limitation by the ambient temperature. Depending on the specific material data of the working fluids that can be used, the condensation and evaporation processes run in isolation even at lower temperatures, with the temperature level of the heat energy to be supplied likewise falling. At a pressure of 1 bar, propane, for example, evaporates at −42.4° C. The required inlet temperature at the heat exchanger thermal acceleration (5) the is then around −24° C. in order to be able to utilize the full volume change work energetically. Other working fluids at the same 1 bar internal pressure, such as ethane (te=−70C), xenon (ts=−82° C.), krypton (te=−134° C.), etc., have even lower temperature levels, which means that both natural energy sources, such as ambient air or the water of the world's oceans, and technologically determined waste heat sources from process cooling or air conditioning, can in principle be used to generate electricity without combustion.

In contrast to the state of the art of clockwise heat-power processes, which are characterized by high temperatures and pressures in the course of the process, differential temperatures between 10 K and 50 K from the evaporation temperature and differential pressures in the milli-bar range are sufficient in the new process. Parameters that by analogy are more suited to meteorology. Wind is generated by complex processes in the atmosphere, driven mainly by solar radiation. Differences in density of various air masses caused by differences in water loading and temperature, cause high and low pressure areas, where cooling in the upper layers causes moisture to condense out as rain. Afterwards, the cold heavier air masses flow back towards low pressure areas. Wind generators (constant pressure turbines) use this natural alternating intensity and directional cycle for CO₂, free power generation.

A preferred embodiment of the invention and its application is shown in FIG. 2;

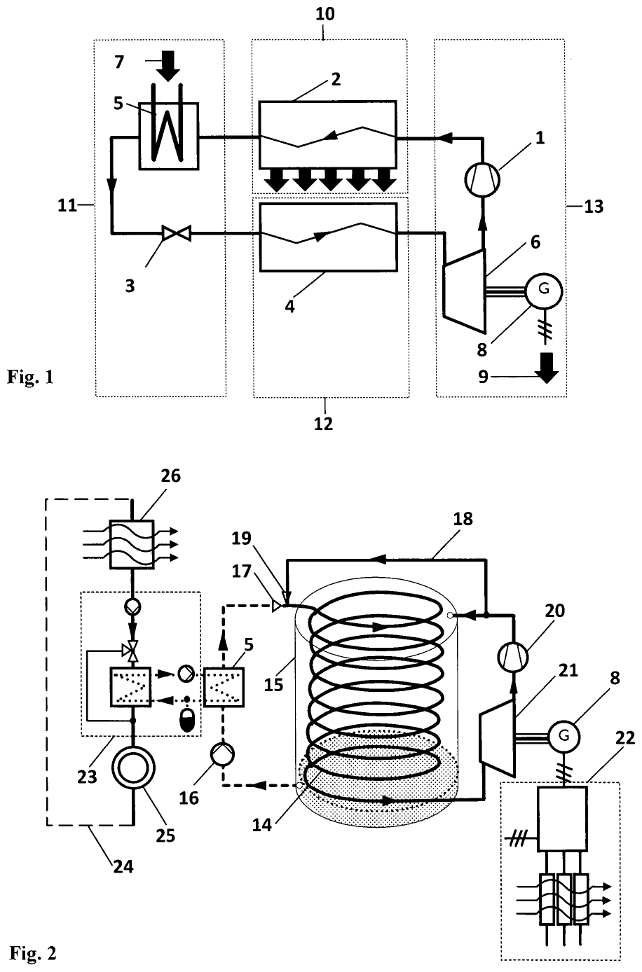

Here, with reference to the basic process FIG. 1, the heat transfer takes place from the cooling heat exchanger (2) to the heating heat exchanger (4) through a coiled tubular heat exchanger (14) located in a tank (15) over its entire length, whereby the flowing working fluid condenses cyclically on the outer tube and drips to the bottom in the tank (15). In the inner tube, the condensate condensed at the inlet evaporates over the entire length of the coiled heat exchanger (14) to the outlet with the same flow cross-section, whereby the fluid velocity accelerates with increasing evaporation. Volume change work (p*ΔV) becomes kinetic energy (Δc²/2). The increase in volume is due to the breaking of molecular bonds from the liquid at constant pressure, for which heat energy is required and the temperature does not rise until all bonds are completely separated. In the case of condensation, this process takes place in the opposite direction. The heat energies required for the phase change circulate in the coiled heat exchanger (14) and thus determine its length. This heat exchanger design promotes wetting of the tube inner surface by centrifugal separation of the heavier liquid droplets through constant change of direction with secondary cross-flows, which intensifies heat transfer and limits the size. In terms of construction effort, this is an important aspect, because for each electrical kW from the process, about 10 kW to 16 kW must circulate internally thermally, depending on the working fluid.

The additional pump (16) is not absolutely necessary according to the basic process FIG. 1, but it improves the practical implementation at the expense of the target variable current. It compensates for pressure losses that occur in the pipeline between the vessel bottom and the swirl nozzle (17) and in the heat exchanger thermal acceleration (5) when conveying the condensate and supplies pressure for the swirl formation. The swirl nozzle (17) at the inlet of the coiled tubing heat exchanger (14) corresponds to the process step of small-volume expansion (3) in FIG. 1.

The flow conditions during internal heat transfer with regard to differential pressure between condensation and evaporation as well as the coordination with the constant-pressure turbine (21) are improved if a gaseous partial mass flow reaches the inlet of the coiled tubular heat exchanger (14) through a bypass (18) from the outlet of the diffuser (20) via the expansion nozzle (19). Although the partial mass flow to be accelerated reduces the fluid velocity, it proportionally increases the mass flow, which means that the kinetic flow energy is retained in a more usable form.

For constant flow conditions in the process, it is necessary for a current control unit (22) to constantly load the constant-pressure turbine (21) after the current is discharged (9) via the generator (8) and to convert the current so that it is ready for use, to serve the power grid by priority and to return the current surplus to the environment via electrical heating resistors. This also includes that a circulation system (23) takes over the thermal heat energy supply (7) to the heat exchanger thermal acceleration (5) independently of the heat source input system (24) with always constant temperature at the same mass flow rate. There is no need to influence the flow for load control, since the process is always operated constantly in the maximum design condition. For this purpose, a heat source input system (24) is required that combines both the waste heat sources from cooling and air conditioning (25) and uses the cooling of the outside air (26) to constantly feed the amount of thermal heat energy (7) into the circulation system (23) without combustion.

The task is thus solved, since the process converts electricity from environmental energy autonomously and covers all load cases up to maximum load, for which in principle all working fluids can be used in the process. CO₂-free power conversion is an important contribution to counteracting climate change.

FIG. 1 shows the basic process for converting thermal energy into electrical energy based on an anticlockwise thermal regenerative cycle combined with thermal acceleration.

FIG. 2 shows the block diagram of the preferred embodiment and its application according to FIG. 1.

Method for Converting Thermal Energy into Electrical Energy Based on an Anticlockwise Thermally Regenerated Cycle Combined with Thermal Acceleration and its Application

### REFERENCE SIGN LIST

1. Large volume compression
2. Heat exchanger cooling
3. Small volume expansion
4. Heat exchanger heating
5. Heat exchanger thermal acceleration
6. Turbine
7. Thermal heat energy supply
8. Generator
9. Current discharge
10. Condensation by heat transfer to evaporation
11. First heating for thermal acceleration and then expansion or reverse order
12. Evaporation by regenerated heat transfer from condensation combined with thermal acceleration
13. First velocity reduction in turbine and then compression or reverse order
14. Coiled tubular heat exchanger
15. Vessel
16. Pump
17. Swirl nozzle
18. Bypass
19. Expansion nozzle
20. Diffuser
21. Equal pressure turbine
22. Flow control unit
23. Circulation system
24. Heat sources input system
25. Waste heat sources from cooling and air conditioning
26. Outside air

1. A method for the conversion of thermal energy into electrical energy based on an anticlockwise thermally regenerated cycle combined with thermal acceleration and its application, consisting of the known basic process steps of the anticlockwise cold steam processes, in which the working fluid cyclically passes through the large-volume compression, the heat exchanger cooling with condensation, the small-volume expansion and the heat exchanger heating with evaporation, wherein:
a.) the heat energy to be dissipated from heat exchanger cooling is completely transferred to the heat exchanger heating,
b.) the large-volume compression and small-volume expansion must only maintain the pressure and temperature difference needed for the heat transfer from the heat exchanger cooling to the heat exchanger heating,
c.) besides the evaporation process in the heat exchanger heating between inlet and outlet, the volume increase is additionally used for increasing the flow energy, for thermal acceleration,
d.) the thermal heat energy supply is carried out with the heat exchanger thermal acceleration,
e.) the heat exchanger thermal acceleration takes over the heat transfer to the flowing working fluid,
f.) the large-volume compression uses parts of the flow energy,
g.) the turbine drives the generator with the main part of the flow energy,
h.) with the current discharge the electric energy is discharged from the process,
i.) the working fluid cyclically passes through the principal process steps: condensation by heat transfer to evaporation, first heating for thermal acceleration and then expansion or reverse sequence, evaporation by regenerated heat transfer from condensation combined with thermal acceleration, first velocity reduction in the turbine and then compression or reverse sequence.

2. The method according to claim 1, wherein the heat transfer from the heat exchanger cooling to the heat exchanger heating is effected by a pipe coil heat exchanger located in a container over the total length thereof.

3. The method according to claim 1, wherein the flowing working fluid condenses cyclically at the coiled heat exchanger on the outer tube and drips to the bottom in the tank

4. The method according to claim 1, wherein the condensate entering the inner tube at the inlet evaporates over the entire length of the coiled heat exchanger up to the outlet with the same flow cross-section.

5. The method according to claim 1, wherein a pump conveys the condensate from the container through the heat exchanger thermal acceleration to the swirl nozzle

6. The method according to claim 1, wherein a gaseous partial mass flow passes through a bypass from the outlet of the diffuser via the expansion nozzle to the inlet of the tubular coil heat exchanger,

7. The method according to claim 1, wherein a current control unit after current derivation via the generator constantly loads the constant-pressure turbine.

8. The method according to claim 1, the current control unit converts the current in a usable manner, serves the power grid by priority and feeds the current surplus back to the environment in a sliding manner via electrical heating resistors.

9. The method according to claim 1, wherein a circulation system takes over the thermal heat energy supply to the heat exchanger thermal acceleration independently of the heat source input system with always constant temperature at the same mass flow rate.

10. The method according to claim 1, wherein the process is constantly always operated in the maximum design state

11. The method according to claim 1, wherein a heat source input system both combines the waste heat sources from cooling and air conditioning and uses the cooling of the outside air to feed the amount for thermal heat energy input into the circulation system without combustion.

12. The method according to claim 1, wherein the process autonomously converts electricity from environmental energy and thereby covers all load cases up to the maximum load.

13. The method according to claim 1, wherein in principle all working fluids can be used in the process.
